(19) United States
(12) Patent Application Publication
(10) Pub. No.: US 2025/0164304 A1
(43) Pub. Date: May 22, 2025

(54) Portable Meter Test Assembly

(71) Applicant: The Ford Meter Box Company, Inc., Wabash, IN (US)

(72) Inventor: Robert W. Huddleston, Twelve Mile, IN (US)

(21) Appl. No.: 18/817,564

(22) Filed: Aug. 28, 2024

Related U.S. Application Data
(60) Provisional application No. 63/600,879, filed on Nov. 20, 2023.

(51) Int. Cl. G01F 25/10

(52) U.S. Cl. CPC G01F 25/10

(57) ABSTRACT

A portable meter test assembly is provided that includes a case. An inlet port is located adjacent the case. An outlet port is located adjacent the container portion of the case. A fluid passageway extends from the inlet port to the outlet port. A pressure gauge, valve, and flow meter are located on the fluid passageway. A power source provides power to the flow meter. The pressure gauge is configured to identify a pressure from a fluid source. The valve is configured to open and close in order to allow and prevent fluid from passing through the fluid passageway. The flow meter is configured to determine a flow rate.

### RELATED APPLICATIONS

The present application relates to and claims priority to U.S. Provisional Patent Application, Ser. No. 63/600,879, filed on Nov. 20, 2023, entitled “Portable Meter Test Assembly.” The subject matter disclosed in that Provisional application is hereby expressly incorporated into the past application.

### TECHNICAL FIELD AND SUMMARY

The present disclosure is directed to fluid meter test assemblies and, particularly, to portable fluid meter test and temporary meter service assemblies.

Fluid meters, such as water meters, are known devices that determine the volume of fluid passing there through. Most business and residential dwellings that have water service, include a meter so the amount of water used can be determined and recorded. This is primarily for billing purposes by the water provider.

A critical aspect of such fluid meters (e.g., water meters) is their accuracy. Being able to determine the correct flow rate of fluid, such as water, passing through the meter ensures the accuracy of the amount of water being used and, thus, the amount of money to be charged to a customer. Because fluid meters can have a long life cycle, a testing program to determine their consistent accuracy is important.

Fluid meter testing systems are known, such as described in U.S. patent application Ser. No. 16/892,402, titled “Automated Measuring System for Meter Test Bench,” the disclosure of which is incorporated herein in its entirety. Typically, one or more meters are taken to a testing facility where they are fluidly coupled to a test assembly and a known volume of water is passed through each meter. Each meter is then read. If the meter reads the same amount as the known water volume, the meter is reading accurately. If the meter reads either less or more, it is creating some percent error.

In certain circumstances, it can be useful to measure meter accuracy in the field without necessarily having to remove the meter in order to test it. An illustrative embodiment of the present disclosure provides a portable meter test assembly. In this case, the portable meter test assembly can be brought to the house or building to check the accuracy of a meter without disconnecting it. The portable meter test assembly is connectable to the home's or building's outside hose bib or spigot. The building's own water meter is not removed. Rather, a volume of water is tested by the portable meter test assembly and compared to the building's water meter to determine its accuracy. If the building's water meter reads within a tolerance, then it remains. If that water meter reads outside the tolerance, it can be pulled for further testing or be replaced.

Accordingly, an illustrative embodiment of the present disclosure provides a portable meter test assembly that includes a case composed of a container portion and a lid; an inlet port located adjacent the container portion of the case; an outlet port located adjacent the container portion of the case opposite the inlet port; a linear fluid passageway extending from the inlet port to the outlet port; a pressure gauge located on the linear fluid passageway adjacent the inlet port; a first valve located on the linear fluid passageway adjacent the pressure gauge; a flow meter located on the linear fluid passageway adjacent the first valve; a second valve located on the linear fluid passageway adjacent the flow meter and opposite the first valve; and a power source located within the case to provide power to the flow meter. The pressure gauge is configured to identify an active line pressure from a fluid source. The first valve is configured to open and close in order to allow and prevent fluid from passing through the linear fluid passageway. The flow meter is configured to determine a flow rate and total volume.

In the above and other illustrative embodiments, the portable meter test assembly may further comprise: the inlet port includes an inlet coupling, wherein the outlet port includes an outlet coupling, and wherein the inlet coupling and the outlet coupling are each located on the exterior of the case; the first valve being a ball valve; the flow meter being configured to determine the flow rate by volume; the flow meter includes a totalizer which is configured to display a predetermined volume of fluid that can be reset to zero; the flow rate determined by the flow meter being displayable in a plurality of unit variations; the second valve being a globe valve to selectively open and close fluid flow from the flow meter to the outlet port; the power source includes one or more batteries to provide the power to the flow meter; one or more battery adapters to accommodate corresponding connection configurations of the one or more batteries, and an inlet plate and an outlet plate both located within the case and each configured to shroud components within the container portion of the case.

Another illustrative embodiment of the present disclosure provides a portable meter test assembly that includes a case composed of a container portion; an inlet port located adjacent the container portion of the case; an outlet port located adjacent the container portion of the case; a fluid passageway extending from the inlet port to the outlet port; a pressure gauge located on the fluid passageway; a valve located on the fluid passageway; a flow meter located on the fluid passageway; and a power source to provide power to the flow meter. The pressure gauge is configured to identify pressure from a fluid source. The valve is configured to open and close in order to allow and prevent fluid from passing through the fluid passageway. The flow meter is configured to determine a flow rate and total volume.

In the above and other illustrative embodiments, the portable meter test assembly may further comprise: the case also includes a lid that is selectively attachable to the case, wherein the lid is configured to store accessories selected from the group consisting of at least one or more adapter, elbow, coupling, battery, battery adapter, and hose; the outlet port being located opposite of the inlet port; the fluid passageway being a linear fluid passageway such that fluid flows in a straight line from the inlet port to the outlet port; the pressure gauge being located adjacent the inlet port; the valve is located adjacent the pressure gauge; the valve being configured to open and close in order to allow and prevent fluid from passing through the fluid passageway; a second valve located on the fluid passageway adjacent the flow meter and opposite the valve; and the power source being located within the case to provide the power to the flow meter.

Another illustrative embodiment of the present disclosure provides a method of administering a flow rate test with a portable meter test assembly. The method of administering the flow rate test comprising steps of: providing a case for the portable meter test assembly which includes an inlet port, a pressure gauge, an inlet valve, a flow meter electrically coupled to a power source, a globe valve, and an outlet port, in fluid communication with each other by a fluid passageway between the inlet port and the outlet port; coupling the inlet port to a fluid source; initiating fluid flow to the inlet port from the fluid source; purging the portable meter test assembly by opening the globe valve then opening the inlet valve for removing air in the fluid passageway; closing the inlet valve after the air has been removed from the fluid passageway; reading a fluid service meter to be tested in order to obtain an initial value; opening the inlet valve; determining, by the flow meter, a predetermined volume of fluid passed through the flow meter; closing the inlet valve once the predetermined volume of fluid has passed through the flow meter; reading the fluid service meter, after the predetermined volume of fluid has passed through the flow meter and the inlet valve has been closed, to determine an end value, calculating a volume of fluid that passed through the fluid service meter using the initial value and the end value; and comparing the predetermined volume of fluid that passed through the flow meter of the portable meter test assembly with the volume of fluid that passed through the fluid service meter.

Additional features and advantages of the portable meter test assembly will become apparent to those skilled in the art upon consideration of the following detailed descriptions of carrying out this portable meter test assembly as presently perceived.

### BRIEF DESCRIPTION OF THE DRAWINGS

The concepts described in the present disclosure are illustrated by way of example and not by way of limitation in the accompanying figures. For simplicity, and clarity of illustration, elements illustrated in the figures are not necessarily drawn to scale. For example, the dimensions of some elements may be exaggerated relative to other elements for clarity. Further, where considered appropriate, reference labels may be repeated among the figures to indicate corresponding or analogous elements.

FIG. 1 is a front view of a portable meter test assembly;

FIG. 2 is an end view of the portable meter test assembly;

FIG. 3 is a perspective view of the portable meter test assembly;

FIG. 4 is a top view of the portable meter test assembly;

FIG. 5 is a front elevational sectional view of the portable meter test assembly; and

FIG. 6 is a perspective view of the portable meter test assembly being used by an operator outside of a building that employs a fluid service meter illustratively located within a pit.

Corresponding reference characters indicate corresponding parts throughout the several views. The exemplification set out herein illustrates embodiments of the portable meter test assembly and such exemplification is not to be construed as limiting the scope of the portable meter test assembly in any manner.

### DISCLOSURE OF ILLUSTRATIVE EMBODIMENTS

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

In another illustrative embodiment, the portable meter test assembly may be deployed as a portable meter service. In the case of sporting events, outdoor concerts, or other gatherings, the portable meter test assembly may, alternatively, be used to provide a temporary metering system for a water supply. The portable meter test assembly may be disassembled after the event or gathering. This allows water service to be provided to the event or gathering, the water measured and recorded, and then a charge submitted for the water use.

An illustrative embodiment of the present disclosure provides a portable meter test assembly composed of a portable case sized to hold a meter testing apparatus while being movable by a single person. The case may include a handle and have a lid that is either removable or pivotable. Regarding the latter, latches and one or more hinges may be employed to pivot the lid between secured closed and accessible open positions. It is contemplated that the meter testing apparatus includes a linear flow path. This is in contrast to a U-shaped or angled flow path. Accordingly, fluid flow input and output may be located on opposite sides of the case. Illustratively, a fluid source can be attached to an inlet coupling exterior of the case. Likewise, the fluid output may be coupled to an outlet coupling also exterior of the case and opposite the inlet coupling.

Inside the case includes a linear fluid passageway extending from the inlet coupling to the outlet coupling. Along that fluid pathway is a pressure gauge at the inlet side which shows the active line pressure from the fluid or water source. A ball valve or other like inlet valve on the inlet side opens and closes to allow or prevent fluid from passing through the meter testing apparatus. Between the inlet side and outlet side is a flow meter that has the capabilities to determine flow rate by volume. Illustratively, the flowmeter may include a totalizer, which displays the volume of throughput, which can be reset to zero, flow rate, which may be customizable in several unit variations, and fluid or water temperature.

Illustratively, on the outlet side, opposite the ball valve and flow meter, is a globe valve to selectively open and close fluid flow from the flow meter to the outlet coupling. Also illustratively located within the case is a portable power source. One or more types of batteries may be employed to provide power to the flow meter. In an illustrative embodiment, connection adapters for different types of batteries may be included within the case so as to accommodate a variety of battery types. For example, typical 18V tool batteries may be cased in different connection configurations for use with cordless power tools like drills or saws. These different connection configurations make it difficult to use these batteries with other devices. By providing adapters for different types of tool batteries, whatever tool batteries someone may have on hand will likely be usable to power the portable meter test assembly.

The case containing the meter test assembly can be brought to any location and, particularly, to the water service or exterior water source for the dwelling, building, or residence. The process for administering the meter test includes illustratively connecting hoses to the inlet and outlet on the case of the portable meter test assembly. The opposite end of the inlet hose is then attached to the water source. This is typically a hose bib or other outside water source of the home or building. The opposite end of the outlet hose is positioned in a swail, drain, sewer, or other location where the water can flow out. With the hoses connected to the water source and case, the portable test system is purged to remove air. First, the globe valve is fully opened followed by the inlet valve. The water source is turned on to allow water to flow through the system, removing the air. During this purge, an operator can also set the desired flow rate using the globe valve based on flow readings from the flowmeter. The globe valve can be partially opened or closed to an extent that achieves the desired flow rate. The inlet valve is then closed. Prior to beginning the actual test, the resident's or building's water service meter is read to obtain an initial value. The meter test can then begin. On the portable meter test assembly, the inlet valve is opened with the flowmeter on the portable test assembly determining the volume of water passing through same. Once the desired volume of water has passed through the meter the inlet valve is closed. The residence's or building's water service meter is then read again. The beginning and end values of the water service meter are used to calculate the volume of water that passed through the meter. That value is then compared to the volume that passed through the flowmeter on the portable meter test assembly. Depending on the difference between the calculated volume of the water service meter and the volume read through the portable meter test assembly, it can be determined whether the water service meter is calculating the volume correctly, with error (within a tolerance), or erroneously. If it is the latter, the water service meter can be removed and replaced. Lastly, the water can be shut off at the hose bib of the residence or building. The hoses attached to the portable meter test assembly case are removed and drained. The portable meter test assembly is drained as well and can be removed and stowed for use at another location.

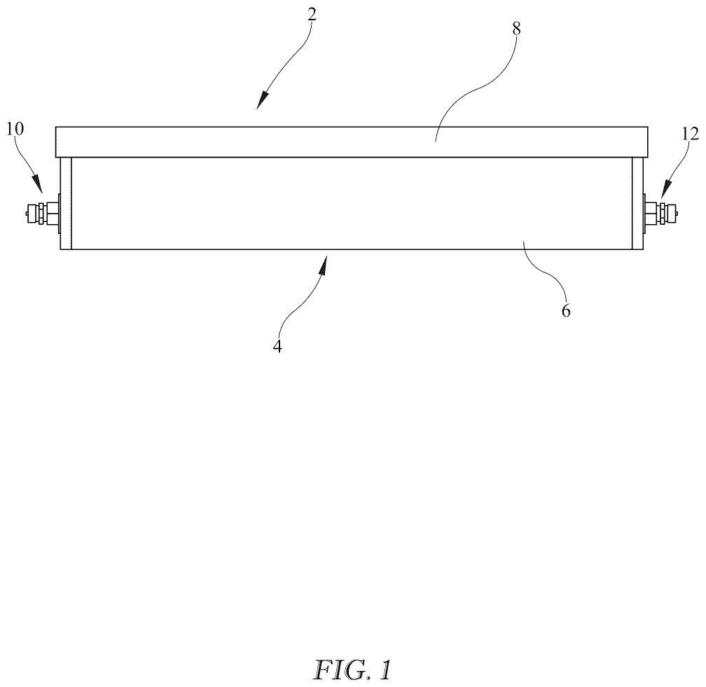

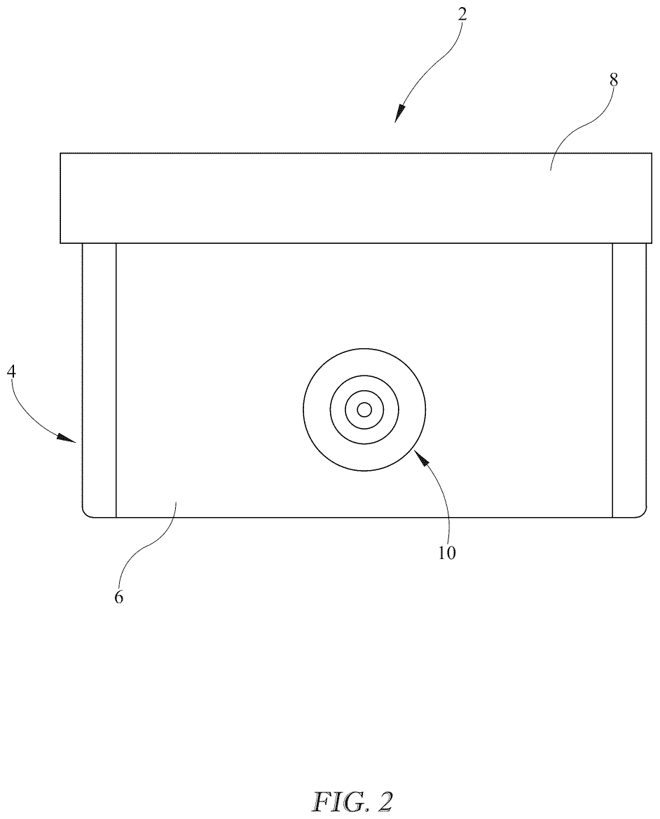

A front view of a portable meter test assembly 2 is shown in FIG. 1. Portable meter test assembly 2 is composed of a case 4 having a container portion 6 and a lid 8. Case 4 allows portable meter test assembly 2 to be carried from place to place. Its compact design enables water service meters to be tested on site without disconnecting them. An inlet port 10 (see, also, FIG. 2) and an outlet port 12 are illustratively located at opposite ends of case 4. Portable meter test assembly 2 is a linear system meaning that water flows straight from the inlet to the outlet. It is appreciated that inlet port 10 and outlet port 12 may be one inch fittings. It is further appreciated, however, that other size fittings, such as three-quarter inch, or other sizes, may be employed. Additionally, portable meter test assembly 2 may include adapters that change the fitting sizes. For example, a ¾ inch adapter can be attached to the one inch fitting so as to couple to a conventional garden hose. This allows portable meter test assembly 2 to be adaptable for various uses such as testing a meter using the hose bib outside of a residence (which uses a three-quarter inch coupling) or as a temporary water meter (which uses a conventional one inch line). In other words, portable meter test assembly 2 has the capability to operate as either a meter tester or a temporary service meter.

An end view of portable meter test assembly 2 is shown in FIG. 2. Here, inlet port 10 is shown disposed through container portion 6 of case 4. Having access to the inlet and outlet ports 10 and 12, respectively, allows an operator to couple inlet and outlet hoses directly to the exterior of case 4.

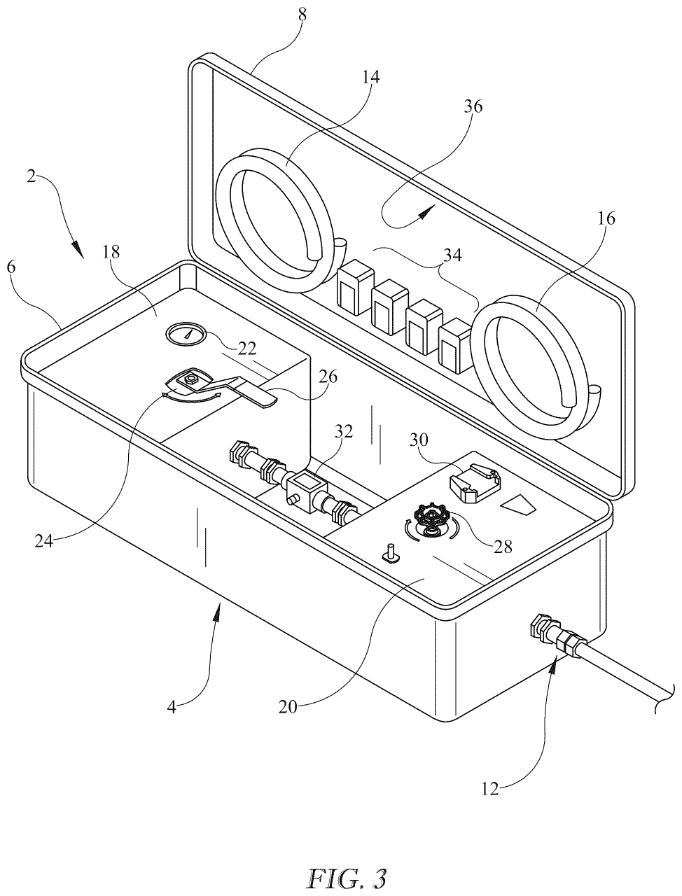

A perspective view of portable meter test assembly 2 is shown in FIG. 3. In this view, lid 8 is pivoted and, thus, raised from container portion 6 showing the contents within. An inlet hose 14 and an outlet hose 16 may be held in placed within lid 8. Illustratively, all of the needed components for use on portable meter test assembly 2 may be included within case 4 so as to be a self-contained system. Couplings or adapters (not shown) that change the size of inlet port 10 and outlet port 12 to accommodate different hoses or fittings, and may also be stowed within case 4. Within container portion 6 is an illustrative inlet plate 18 and an outlet plate 20 that each shroud components of portable meter test assembly 2 for aesthetic purposes. Shown in this view on the inlet side is pressure gauge 22 and inlet valve 24. Pressure gauge 22 determines the amount of pressure created by the incoming fluid. A handle 26 on inlet valve 24 extends from inlet plate 18. Illustratively, inlet valve 24 may be a ball valve that is opened or closed by pivoting handle 26. Illustratively, indicia on inlet plate 18 indicates to the operator the positioning of inlet valve 24 according to where handle 26 is located with respect to inlet plate 18.

On the opposite end of container portion 6 of case 4 is outlet plate 20 that shrouds globe valve 28 and supports battery mount 30. Globe valve 28 is used on the outlet side to control flow rate. A battery coupled to mount 30 powers flowmeter 32 illustratively located between inlet plate 18 and outlet plate 20. It is appreciated, however, that flowmeter 32 may be located at any position between inlet valve 24 and globe valve 28. An illustrative embodiment of the flowmeter may include flow rate, volume, etc.

It will be appreciated by the skilled artisan upon reading this disclosure that the size and character of battery mount 30 may be configured to accommodate the power needs of flowmeter 32. In further embodiments, battery mount 30 may be configured to receive a variety of battery adapters 34. As shown in FIG. 3, inlet and outlet hoses 14 and 16, respectively, are removably coupled to interior cavity 36 of lid 8. Also shown are a plurality of battery adapters 34 that each may also be removably coupled to interior cavity 36 of lid 8. Each of the plurality of adapters 34 may be configured to accommodate a particular power tool battery configuration. For example, battery-powered tools from Dewalt, Milwaukee, Hitachi, Bosch, etc., may all be 18, 20, 24, etc. volt batteries, but each of their connection interfaces are different. It is contemplated that adapters 34 can each accommodate a different popular brand power tool battery configuration and couple to battery mount 30 to allow the battery to supply the needed power. This provides flexibility to the operator so that, regardless of the type of power tool battery that the operator might have, portable meter test assembly 2 can accommodate that battery via one of the plurality of battery adapters 34. The power tool battery, once connected to battery adapter 34, which is coupled to battery mount 30, supplies power. It is appreciated that the batteries can be removably mounted to a corresponding adapter 34 and that corresponding adapter can be removably mounted to battery mount 30. In other embodiments, other power sources may be used including any variety of batteries, plug-in power supply, solar, etc.

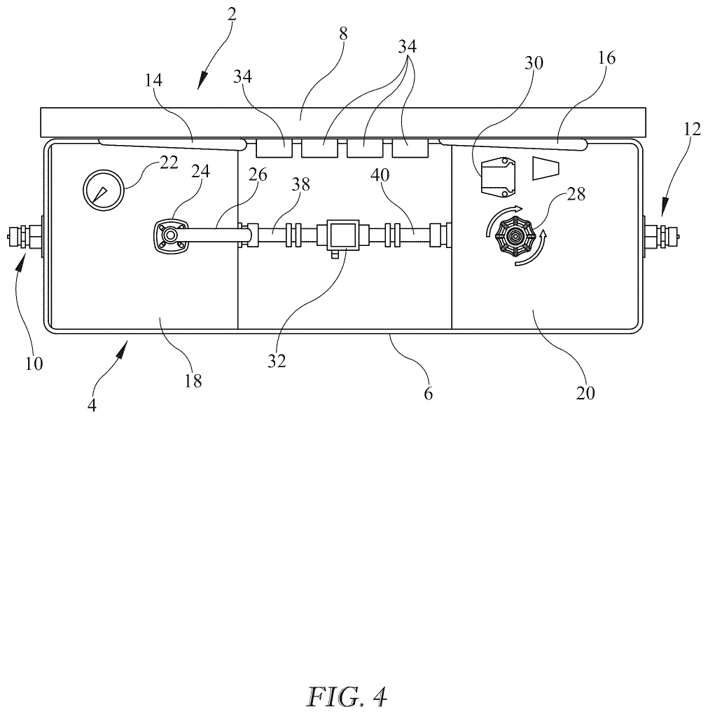

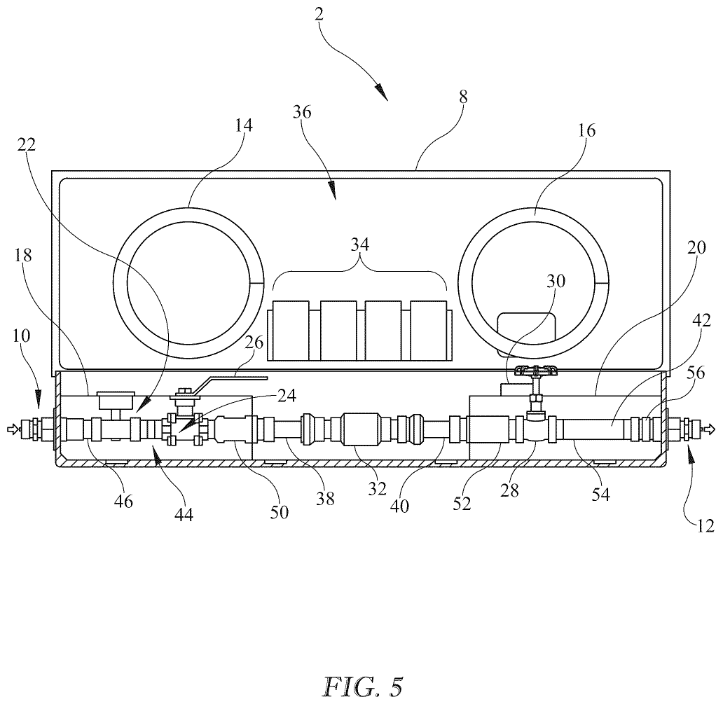

A top view of portable meter test assembly 2 is shown in FIG. 4. This view depicts lid 8 of case 4 in an upright position exposing the contents in container portion 6. This view also demonstrates how portable meter test assembly 2 has a linear fluid flow with inlet port 10 located axially opposite outlet port 12. A passageway composed of various pipe sections and couplings (see FIG. 5) fluidly couples inlet port 10 to outlet port 12. This view also depicts the illustrative positioning of pressure gauge 22 and inlet valve 24 located on the inlet side as indicated by inlet plate 18 and globe valve 28 and battery mount 30 located on the outlet side indicated by outlet plate 20. Flowmeter 32 is shown coupled to opposing pipe sections 38 and 40 on opposing sides. Also shown in this view are battery adapters 34, inlet hose 14, and outlet hose 16, all held within interior cavity 36 (see FIG. 3) of lid 8. It is further appreciated that other accessories, such as adapters, elbows, couplings, etc., may be stowed either in interior cavity 36 of lid 8 or in container portion 6 of case 4.

A front elevation sectional view of portable meter test assembly 2 is shown in FIG. 5. This view, in particular, depicts the linear passageway of the fluid flow as indicated by directional arrow 42. Fluid enters inlet port 10, flows linearly through fluid passageway 44, according to directional arrow 42, and exits from outlet port 12. Flowmeter 32, positioned in line with fluid passageway 44, calculates the flow rate and meters the volume of fluid passing through portable meter test assembly 2. Again, flowmeter 32 is powered via a power source such as a battery attached at battery mount 30.

Fluid passageway 44, as shown in this view, is illustratively composed of several components. First, inlet port 10 is connected to a coupling or nipple 46 that connects inlet port 10 to pressure gauge 22. Depending on the length needed between pressure gauge 22 and inlet valve 24, another coupling or nipple 46 is located therebetween connecting these structures together to continue fluid passageway 44. Coupling portion 50 of pipe section 38 connects inlet valve 24 to pipe section 38. Flowmeter 32 is also fluidly attachable to pipe section 38 (either directly or with the assistance of a coupling or an adapter) creating a straight-line passageway (i.e., fluid passageway 44) from inlet port 10 through flowmeter 32. The outlet side of flowmeter 32 couples to pipe section 40. Globe valve 28 is coupled to coupling portion 52 of pipe section 40 at the inlet side and to coupling or nipple 54 at the outlet side. It is appreciated that the couplings, nipples, pipe sections, and/or adapters may be sized, not only in diameter, but also in length to accommodate the necessary fluid passageway that allows for the pressure gauge, inlet valve, flowmeter, and globe valve to be packaged in a portable case, as well as serve as part of meter test assembly 2.

Coupling or nipple 54 is then attached at its outlet side to another coupling 56, which attaches to outlet port 12. This view also shows, illustratively, inlet hose 14, outlet hose 16, and battery adapters 34 removably held to interior cavity 36 of lid 8. It is appreciated that inlet plate 18 and outlet plate 20 can shroud much of the couplings and valves on the inlet and outlet sides of fluid passageway 44. This view, thus, demonstrates how entire portable meter test assembly 2 can be fitted into case 4 in order to be carried to any desired location. Additionally, inlet port 10 and outlet port 12 can be configured to accept adapters that can connect to conventional garden hoses or other water supply connections.

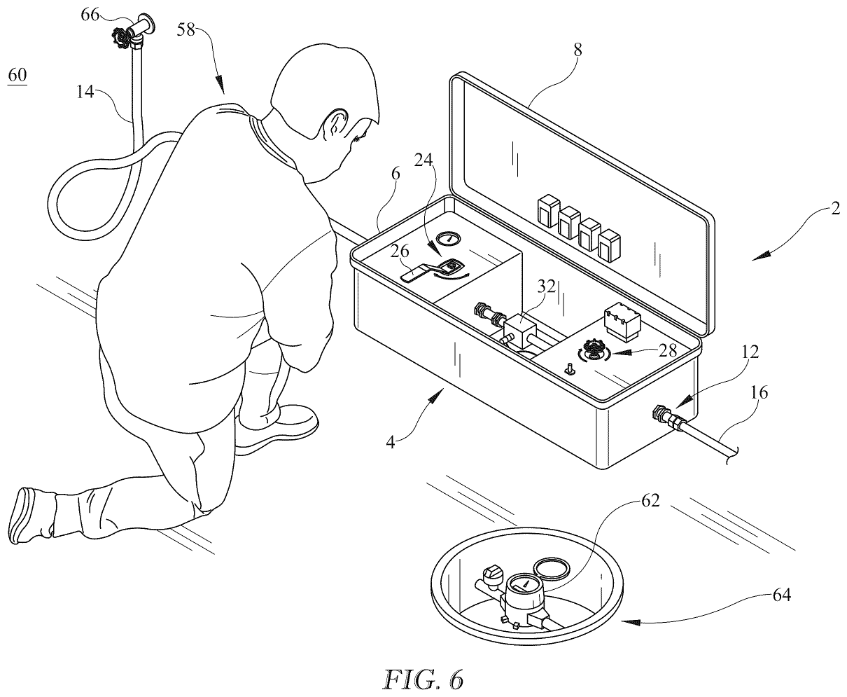

A perspective view of portable meter test assembly 2 being used by an operator 58 outside a building 60 that employs a fluid service meter 62, illustratively located within a pit 64, is shown in FIG. 6. This view demonstrates an illustrative operation of portable meter test assembly 2. Here, water or other fluid that enters building 60 will be monitored using service meter 62. Often, such meters are located within pits such as pit 64 shown herein. The first step is to connect a water source from building 60 to portable meter test assembly 2. In this case, a hose bib 66, attached to building 60, is able to supply water that passes through fluid service meter 62, as shown, having inlet hose 14 attached to hose bib 66 at one end and inlet port 10 of portable meter test assembly 2 at the other end (not shown in this view). This supplies metered water into meter test assembly 2. Outlet hose 16 is attached to outlet port 12 as well. It is appreciated that adapters can be used on both inlet port 10 and outlet port 12, as needed, to attach the hoses or other piping to portable meter test assembly 2. In an illustrative embodiment, inlet port 10 and outlet port 12 may have one-inch couplings for purposes of temporary meter service for venues or events where non-permanent water services are needed. Adapters can be coupled to the one-inch outlet port 10 and outlet port 12 to accommodate conventional three-quarter inch hose bibs, for example. It is appreciated that any number of adapters can be employed to accommodate pipes or hoses of any variety of diameters so they can be coupled to portable meter test assembly 2 and, particularly, to inlet port 10 and outlet port 12 in order to meter the fluid passing therethrough. It is further appreciated that outlet hose 16 can be directed to any appropriate location that will allow water exiting outlet hose 16 to drain. This could be a field, sewer system, conduit, etc.

With portable meter test assembly 2 connected to a water source and fluid outlet, portable meter test assembly 2 can be purged by opening hose bib 66 to begin fluid flow through inlet hose 14 and into nipple 46 (see FIG. 5). Both inlet valve 24 and globe valve 28 are opened to purge air through passageway 44 from inlet port 10 to outlet port 12. Additionally, the desired flow rate can be controlled using globe valve 28 and flow readings from flowmeter 32. Optionally, an additional shut-off valve (not shown) may be placed in passageway 44 after globe valve 28 if needed to further ensure air remains purged from the passageway when the test begins. If this shut-off valve is used it will be opened as well when the test begins.

Once the air is purged and the flow rate set, inlet valve 24 is closed, illustratively, via handle 26. Prior to starting the test, and after inlet valve 24 is open again, fluid service meter 62 is read and documented. Documenting the reading from fluid service meter 62 provides a start value so that when the test is concluded and the end value read, the fluid or water volume can be calculated to determine how closely fluid service meter 62 reads compared to flowmeter 32 of portable meter test assembly 2. With fluid service meter 62 read, the test can begin by opening inlet valve 24 via handle 26. The desired volume of water is then run through flowmeter 32 of portable meter test assembly 2.

The test begins by opening inlet valve 24 via handle 26. The water or other fluid is allowed to run to a predetermined volume. Once that predetermined volume has been reached, inlet valve 24 is closed. With inlet valve 24 closed, fluid service meter 62 is read again and documented. The volume difference recorded by fluid service meter 62 versus flowmeter 32 is determined. If that difference exceeds a predetermined tolerance, then fluid service meter 62 can be removed to be repaired or replaced. In either event, when the test is concluded, hose bib 66 is shut off. Inlet hose 14 and outlet hose 16 are disconnected from respective inlet and outlet ports, rolled up, and placed in case 4 of portable meter test assembly 2. The battery can be removed from battery mount 30 and lid 8 closed onto container portion 6 to allow portable meter test assembly 2 to be latched and stowed.

In addition to being usable for testing water meters, such as fluid service meter 62, in the field, portable meter test assembly 2 may alternatively serve as a temporary water meter unit. Under certain circumstances, when temporary water service is required for gatherings or events, portable meter test assembly may be attached to a water source at the inlet port and water distribution at the outlet port. Flowmeter 32 can record the volume of water used at the event and then removed and packed away when the event is over. The volume of water used during the event can be recorded for whatever purposes, including remittance for payment. Illustratively, inlet port 10 and outlet port 12 can be one-inch diameter fittings conventional to many building water service inlets.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. It should also be appreciated that any subject matter disclosed in this non-provisional patent application that may differ from the priority application, the disclosure from this non-provisional patent application controls.

What is claimed:

1. A portable meter test assembly comprising:
a case composed of a container portion and a lid;
an inlet port located adjacent the container portion of the case;
an outlet port located adjacent the container portion of the case opposite the inlet port;
a linear fluid passageway extending from the inlet port to the outlet port;
a pressure gauge located on the linear fluid passageway adjacent the inlet port;
wherein the pressure gauge is configured to identify an active line pressure from a fluid source;
a first valve located on the linear fluid passageway adjacent the pressure gauge;
wherein the first valve is configured to open and close in order to allow and prevent fluid from passing through the linear fluid passageway;
a flow meter located on the linear fluid passageway adjacent the first valve;
wherein the flow meter is configured to determine a flow rate;
a second valve located on the linear fluid passageway adjacent the flow meter and opposite the first valve; and
a power source located within the case to provide power to the flow meter.

2. The portable meter test assembly of claim 1, wherein the inlet port includes an inlet coupling, wherein the outlet port includes an outlet coupling, and wherein the inlet coupling and the outlet coupling are each located on the exterior of the case.

3. The portable meter test assembly of claim 1, wherein the first valve is a ball valve.

4. The portable meter test assembly of claim 1, wherein the flow meter is configured to determine the flow rate by volume.

5. The portable meter test assembly of claim 1, wherein the flow meter includes a totalizer, which is configured to display a predetermined volume of fluid that can be reset to zero.

6. The portable meter test assembly of claim 1, wherein the flow rate determined by the flow meter is displayable in a plurality of unit variations.

7. The portable meter test assembly of claim 1, wherein the second valve is a globe valve to selectively open and close fluid flow from the flow meter to the outlet port.

8. The portable meter test assembly of claim 1, wherein the power source includes one or more batteries to provide the power to the flow meter.

9. The portable meter test assembly of claim 8, further comprising one or more battery adapters to accommodate corresponding connection configurations of the one or more batteries.

10. The portable meter test assembly of claim 8, further comprising an inlet plate and an outlet plate, both located within the case, and each configured to shroud components within the container portion of the case.

11. A portable meter test assembly comprising:
a case composed of a container portion;
an inlet port located adjacent the container portion of the case;
an outlet port located adjacent the container portion of the case;
a fluid passageway extending from the inlet port to the outlet port;
a pressure gauge located on the fluid passageway;
wherein the pressure gauge is configured to identify a pressure from a fluid source;
a valve located on the fluid passageway;
wherein the valve is configured to open and close in order to allow and prevent fluid from passing through the fluid passageway;
a flow meter located on the fluid passageway;
wherein the flow meter is configured to determine a flow rate; and
a power source to provide power to the flow meter.

12. The portable meter test assembly of claim 11, wherein the case also includes a lid that is selectively attachable to the case, wherein the lid is configured to store accessories selected from the group consisting of at least one or more adapter, elbow, coupling, battery, battery adapter, and hose.

13. The portable meter test assembly of claim 11, wherein the outlet port is located opposite of the inlet port.

14. The portable meter test assembly of claim 11, wherein the fluid passageway is a linear fluid passageway such that fluid flows in a straight line from the inlet port to the outlet port.

15. The portable meter test assembly of claim 11, wherein the pressure gauge is located adjacent the inlet port.

16. The portable meter test assembly of claim 11, wherein the valve is located adjacent the pressure gauge.

17. The portable meter test assembly of claim 11, wherein the valve is configured to open and close in order to allow and prevent fluid from passing through the fluid passageway.

18. The portable meter test assembly of claim 11, further comprising a second valve located on the fluid passageway adjacent the flow meter and opposite the valve.

19. The portable meter test assembly of claim 11, wherein the power source is located within the case to provide the power to the flow meter.

20. A method of administering a flow rate test with a portable meter test assembly, the method of administering the flow rate test comprising steps of:
providing a case for the portable meter test assembly, which includes an inlet port, a pressure gauge, an inlet valve, a flow meter electrically coupled to a power source, a globe valve, and an outlet port, in fluid communication with each other by a fluid passageway between the inlet port and the outlet port;
coupling the inlet port to a fluid source;
initiating fluid flow to the inlet port from the fluid source;
purging the portable meter test assembly by opening the globe valve then opening the inlet valve for removing air in the fluid passageway;
closing the inlet valve after the air has been removed from the fluid passageway;
reading a fluid service meter to be tested in order to obtain an initial value;
opening the inlet valve;
determining, by the flow meter, a predetermined volume of fluid passed through the flow meter;
closing the inlet valve once the predetermined volume of fluid has passed through the flow meter;
reading the fluid service meter, after the predetermined volume of fluid has passed through the flow meter and the inlet valve has been closed, to determine an end value;
calculating a volume of fluid that passed through the fluid service meter using the initial value and the end value; and
comparing the predetermined volume of fluid that passed through the flow meter of the portable meter test assembly with the volume of fluid that passed through the fluid service meter.
